(19) United States
(12) Patent Application Publication
(10) Pub. No.: US 2010/0284265 A1
(43) Pub. Date: Nov. 11, 2010

(54) SEQUENCE NUMBER ESTABLISHING METHOD, WIRELESS COMMUNICATION TERMINAL APPARATUS AND WIRELESS COMMUNICATION BASE STATION APPARATUS

(75) Inventors: Yoshihiko Ogawa, Osaka (JP); Daichi Imamura, Osaka (JP); Sadaki Futagi, Miyagi (JP); Takashi Iwai, Miyagi (JP); Atsushi Matsumoto, Miyagi (JP); Tomofumi Takata, Miyagi (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/810,814

(22) PCT Filed: Dec. 26, 2008
(86) PCT No.: PCT/JP2008/004000

§ 371 Date: Jun. 28, 2010

(30) Foreign Application Priority Data
Dec. 27, 2007 (JP) 2007-337241

(51) Int. Cl. H04J 11/00

(52) U.S. Cl. 370/208

(57) ABSTRACT

A wireless communication terminal apparatus wherein the occurrences of inter-sequence interferences between cells can be reduced. In this apparatus, a sequence number deciding part (105) has a table in which the sequence numbers of a plurality of Zadoff-Chu sequences having different sequence lengths are associated with the sequence group numbers of a plurality of sequence groups into which the Zadoff-Chu sequences are grouped and with the transmission bandwidths of reference signals. In accordance with a sequence group number and a transmission bandwidth both received from a decoding part (104), the sequence number deciding part (105) refers to the table to decide the sequence number of a Zadoff-Chu sequence. In the table of the sequence number deciding part (105), different sequence-number start-positions are established for the Zadoff-Chu sequences having the different sequence lengths.

### TECHNICAL FIELD

The present invention relates to a sequence index setting method, a radio communication terminal apparatus and a radio communication base station apparatus.

### BACKGROUND ART

In a mobile communication system, a reference signal (RS) is used for uplink or downlink channel estimation. In a radio communication system represented by a 3GPP LTE system (3rd Generation Partnership Project Long Term Evolution), a Zadoff-Chu sequence (hereinafter “ZC sequence”) is adopted as a reference signal that is used in uplink. Reasons that a ZC sequence is adopted as a reference signal include a uniform frequency characteristic, and good auto-correlation and cross-correlation characteristics. A ZC sequence is a kind of CAZAC (Constant Amplitude and Zero Auto-correlation Code) sequence and its time-domain representation by following equation 1,

$$\begin{matrix}( Equation 1 ) & \\ {f}_{r} ( k ) = \{ \begin{matrix}\begin{matrix}exp \{ \frac{- j2π r}{N} ( \frac{k ( k + 1 )}{2} + pk ) \} , when N is odd , \\ k = 0 , 1 , … , N - 1\end{matrix} \\ \begin{matrix}exp \{ \frac{- j2π r}{N} ( \frac{{k}^{2}}{2} + pk ) \} , when N is even , \\ k = 0 , 1 , … , N - 1\end{matrix}\end{matrix} & [ 1 ]\end{matrix}$$

where “N” is the sequence length, “r” is ZC sequence index in the time-domain, and “N” and “r” are coprime. Also, “p” represents an arbitrary integer (generally p=0). Although cases will be explained with the following explanation using ZC sequences where sequence length N is an odd number, ZC sequences where sequence length N is an even number will be equally applicable.

A cyclic shift ZC sequence obtained by cyclic-shifting the ZC sequence of equation 1 in the time domain, or a ZC-ZCZ (Zadoff-Chu Zero Correlation Zone) sequence, is represented by following equation 2,

$$\begin{matrix}( Equation 2 ) & \\ {f}_{r , m} ( k ) = exp \{ \frac{- j2π r}{N} ( \frac{( k \pm m Δ ) ( k \pm m Δ + 1 )}{2} ) + pk \} , when N is odd , k = 0 , 1 , … N - 1 & [ 2 ]\end{matrix}$$

where “m” represents the cyclic shift index and “Δ” represents the cyclic shift interval, and the sign “±” is either positive or negative. Further, N−1 quasi-orthogonal sequences with good cross-correlation characteristics can be generated from a ZC sequence of sequence length N of a prime number. In this case, the cross-correlation between generated N−1 quasi-orthogonal sequences is constant at vN. Furthermore, the sequence obtained by Fourier-transforming the time-domain ZC sequence of equation 1 to a frequency-domain sequence is also a ZC sequence, and therefore a frequency-domain ZC sequence is represented by following equation 3,

$$\begin{matrix}( Equation 3 ) & \\ {F}_{u} ( k ) = exp \{ \frac{- j2π u}{N} ( \frac{k ( k + 1 )}{2} + q k ) \} , when N is odd , k = 0 , 1 , … , N - 1 & [ 3 ]\end{matrix}$$

where “N” is the sequence length, “u” is the ZC sequence index in the frequency domain, and “N” and “u” are coprime. Also, “q” represents an arbitrary integer (generally Likewise, in the frequency-domain representation of the time-domain ZC-ZCZ sequence of equation 2, cyclic shift and phase rotation form a Fourier transform pair, and therefore a frequency-domain ZC-ZCZ sequence is represented by following equation 4,

$$\begin{matrix}( Equation 4 ) & \\ {F}_{u , m} ( k ) = exp \{ \frac{- j2π u}{N} ( \frac{k ( k + 1 )}{2} + q k ) \pm \frac{j2πΔ m}{N} k \} , when N is odd , k = 0 , 1 , … , N - 1 & [ 4 ]\end{matrix}$$

where “N” is the sequence length, “u” is the ZC sequence index in the frequency domain, and “N” and “u” are coprime, and where “m” represents the cyclic shift index, “Δ” represents the cyclic shift interval and “q” represents an arbitrary integer (generally q=0).

Further, a reference signal used in an uplink in 3GPP LTE includes a reference signal for channel estimation used to demodulate data (hereinafter “DM-RS,” which stands for demodulation reference signal). This DM-RS is transmitted in the same bandwidth as a data transmission bandwidth. That is, when the data transmission bandwidth is narrow, a DM-RS is transmitted in a narrow band. For example, if the data transmission bandwidth is one RB (resource block), the DM-RS transmission bandwidth is also one RB, and, if the data transmission bandwidth is two RBs, the DM-RS transmission bandwidth is also two RBs. In 3GPP LTE, one RB is formed with twelve subcarriers, so that a DM-RS is transmitted in a transmission bandwidth of an integral multiple of twelve subcarriers. Further, sequence length N of a ZC sequence is the maximum prime number among the prime numbers less than the number of subcarriers equivalent to the transmission bandwidth. For example, if a DM-RS is transmitted in 3 RBs (36 subcarriers), a ZC sequence of sequence length N=31 is generated, and, if a DM-RS is transmitted in 4 RBs (48 subcarriers), a ZC sequence of sequence length N=47 is generated.

A ZC sequence having sequence length N of a prime number, does not match the number of subcarriers equivalent to the DM-RS transmission bandwidth (integral multiple of 12). Then, to match a ZC sequence having sequence length N of a prime number with the number of subcarriers equivalent to the DM-RS transmission bandwidth, a ZC sequence of a prime number is subject to cyclic extension, to match the number of subcarriers in the transmission band. For example, by duplicating the first half of a ZC sequence and attaching the duplicated part to the second half, the number of subcarriers equivalent to the transmission bandwidth is matched with the sequence length of the ZC sequence. To be more specific, in cases where there is a 3-RB (36 subcarriers) DM-RS, cyclic extension of 5 subcarriers is given to the ZC sequence of sequence length N=31, and a ZC sequence of sequence length N=36 is generated, and when a DM-RS is transmitted in 4 RBs (48 subcarriers), cyclic extension of 1 subcarrier is given to the ZC sequence of sequence length N=47 and a ZC sequence of sequence length N=48 is generated.

As described above, in 3GPP LTE, sequence length N varies depending on the reference signal transmission bandwidth (i.e. the number of RBs). Accompanying this, when the transmission bandwidth varies, the sequence index of the ZC sequence used for a reference signal also varies. Then, in 3GPP LTE, studies are underway to group a plurality of ZC sequences of different sequence lengths N into a plurality of sequence groups. A plurality of sequence groups generated by this grouping method are allocated to cells on a one-by-one basis. In 3GPP LTE, the number of sequence groups is 30 (=N−1), which is equivalent to the number of ZC sequences of sequence length N=31 that can be generated from 3 RBs, that is, generated from the minimum transmission bandwidth (i.e. the minimum number of RBs) using a ZC sequence. Further, in the transmission bandwidths, one sequence is assigned to RBs from 3 RBs to 5 RBs per one sequence group, and two sequences are assigned to RBs of 6 RBs or more per one sequence group.

As a method of grouping ZC sequences, a method of assigning ZC sequences to sequence groups in each transmission bandwidth (i.e. each number of RBs) in order from a smaller sequence index, is proposed (e.g. see Non-Patent Document 1). To be more specific, as shown in FIG. 1, in transmission bandwidths of 3 RBs to 5 RBs to which one sequence is assigned per one sequence group, one of ZC sequences of sequence indexes u=1, 2 and 3 . . . is assigned to sequence groups 1, 2 and 3 . . . . Further, as shown in FIG. 1, transmission bandwidths of 6-RBs or more to which two sequences are assigned per sequence group, the two ZC sequences having sequence indexes u=(1, 2), (3, 4) and (5, 6) . . . are assigned to sequence groups 1, 2 and 3 . . . . In this way, sequence indexes of ZC sequences used for reference signals of transmission bandwidths (i.e. the number of RBs) are assigned in order from a smaller sequence index, so that, sequence groups can be determined using a small amount of calculation.

### Non-Patent Document 1: Huawei, R1-073518, “Sequence Grouping Rule for UL DM-RS,” 3GPP TSG RAN WG1 Meeting #50, Athens, Greece, Aug. 20-24, 2007

### DISCLOSURE OF INVENTION

### Problems to be Solved by the Invention

FIG. 2 shows the distribution of u/N of ZC sequences (ZC sequences of sequence indexes u shown in FIG. 1) grouped into a plurality of sequence groups by the above-described conventional technique. The horizontal axis shows u/N and the lateral axis shows a transmission bandwidth (i.e. the number of RBs). As shown in FIG. 2, u/N of ZC sequences used for reference signals tend closely to be zero when the ZC sequences has a wider transmission bandwidth (i.e. the number of wider RBs). That is, between cells to which different sequence groups are assigned, with the above-described conventional technique, it is likely to use ZC sequences having the difference in u/N close to zero between ZC sequences having u/N close to zero.

Here, it is known that combinations of sequence indexes of high cross-correlation are present in ZC sequences of varying sequence lengths. According to computer simulations conducted by the present inventors, the relationships between u/N and the maximum cross correlation value are as shown in FIG. 3. FIG. 3 shows cross-correlation between a desired wave of 1 RB transmission bandwidth and interference waves of transmission bandwidths of 1 RB to 25 RBs. The horizontal axis shows the difference in u/N between the desired wave and interference waves, and the lateral axis shows the maximum cross-correlation values between the desired wave and interference waves. From FIG. 3, when the difference in u/N between ZC sequences becomes close to zero (e.g. the difference in u/N is within 0.02), it is found out that the maximum cross-correlation value between those ZC sequences increases (e.g. the maximum cross-correlation value is equal to or more than 0.7). That is, when ZC sequences showing a difference in u/N close to zero are used at the same time between different cells, the ZC sequence used for the reference signal for one cell is significantly interfered from ZC sequences used for a reference signal for the other cell, and therefore, an error occurs in a channel estimation result.

For example, with reference to the second ZC sequence from the head of a 3-RB transmission bandwidth, it is found out that many ZC sequences of varying sequence lengths are included in the range where difference in u/N from that ZC sequence is within 0.02 (the dotted frame shown in FIG. 2). Inter-sequence interference is likely to occur between these ZC sequences of varying sequence lengths. That is, ZC sequence is grouped simply in order from a smaller number of sequence index as the above-described conventional technique, inter-sequence interference is more likely to occur between cells to which different sequence groups are assigned.

It is therefore an object of the present invention to provide a sequence index setting method, a radio communication terminal apparatus and a radio communication base station apparatus that can reduce the occurrence of inter-sequence interference between cells.

### Means for Solving the Problem

The sequence index setting method of the present invention that uses, as reference signals, Zadoff-Chu sequences having sequence lengths according to reference signal transmission bandwidths includes determining start positions of different sequence indexes at the Zadoff-Chu sequences having different sequence lengths.

### ADVANTAGEOUS EFFECTS OF INVENTION

According to the present invention, it is possible to reduce the occurrence of inter-sequence interference between cells.

### BRIEF DESCRIPTION OF DRAWINGS

FIG. 1 shows a conventional table for determining sequence indexes;

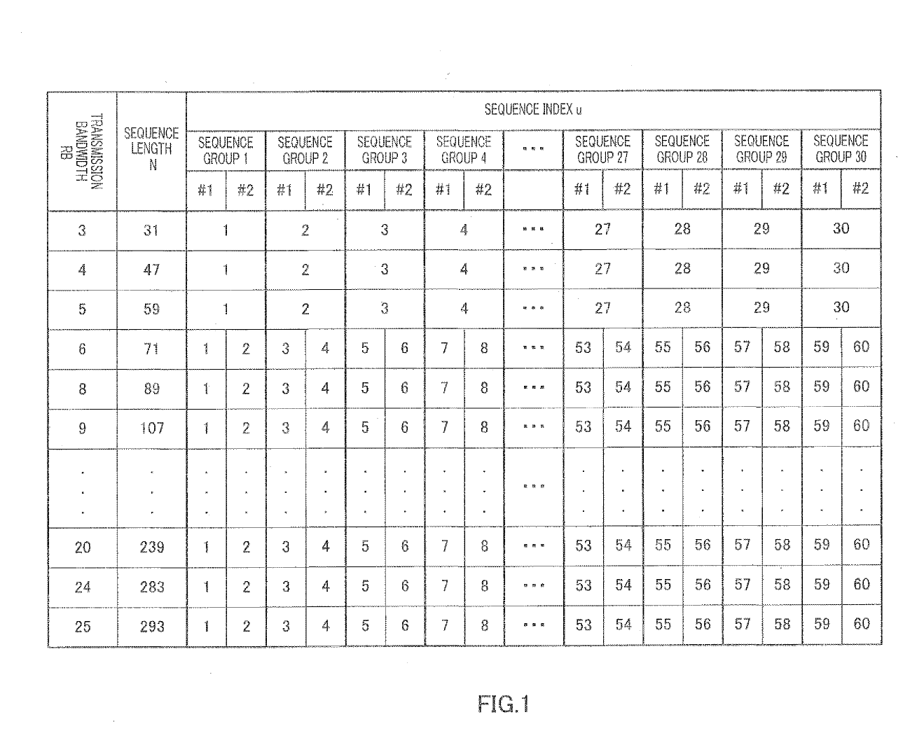

FIG. 2 shows conventional distribution of u/N of ZC sequences to use for reference signals;

FIG. 3 shows cross-correlation for difference in u/N between ZC sequences of varying sequence lengths;

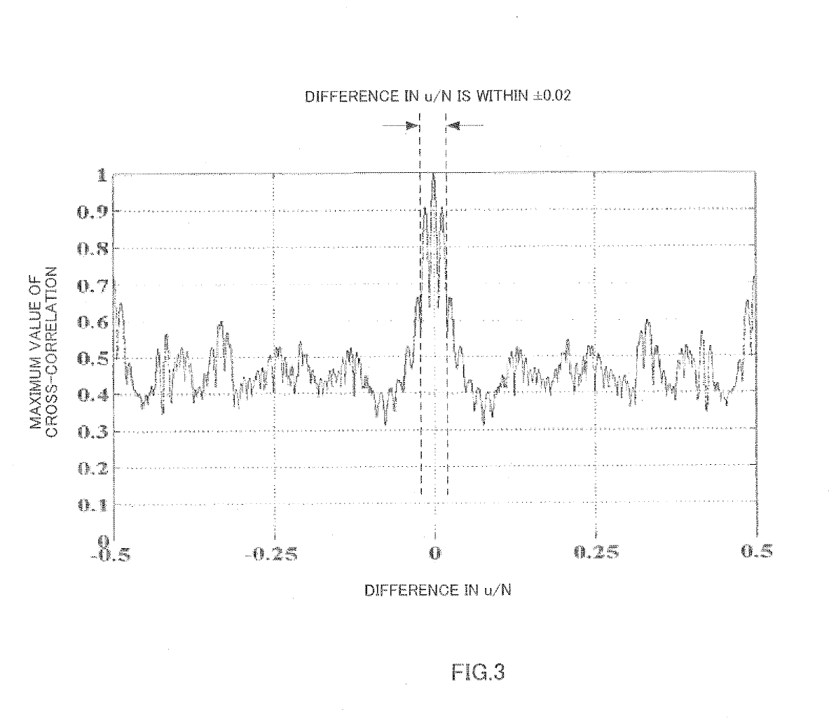

FIG. 4 is a block diagram showing a configuration of a terminal according to Embodiment 1 of the present invention;

FIG. 5 is a block diagram showing a configuration of a base station according to Embodiment 1 of the present invention;

FIG. 6 shows a table for determining sequence indexes according to Embodiment 1 of the present invention;

FIG. 7 shows the distribution of u/N of ZC sequences to use for reference signals according to Embodiment 1 of the present invention;

FIG. 8 shows another table for determining sequence indexes according to Embodiment I of the present invention;

FIG. 9 shows another distribution of u/N of ZC sequences to use for reference signals according to Embodiment 1 of the present invention;

FIG. 10 is a block diagram showing another internal configuration of the reference signal generation section according to Embodiment 1 of the present invention;

FIG. 11 shows a table for determining sequence indexes according to Embodiment 2 of the present invention;

FIG. 12 shows the distribution in u/N of ZC sequences to use for reference signals according to Embodiment 2 of the present invention;

FIG. 13 shows a table for determining sequence indexes according to Embodiment 3 of the present invention;

FIG. 14 shows the distribution in u/N of ZC sequences to use for reference signals according to Embodiment 3 of the present invention; and

FIG. 15 shows another distribution in u/N of ZC sequences to use for reference signals according to the present invention.

### BEST MODE FOR CARRYING OUT THE INVENTION

Now, embodiments of the present invention will be described in detail with reference to the accompanying drawings.

### Embodiment 1

With the present embodiment, the start positions of different sequence indexes are determined in the range of ZC sequences having varying sequence lengths and used for reference signals. Further, the stating positions are determined such that one or more ranges of ZC sequences to use for reference signals in transmission bandwidths of 4 RBs or more are included in the range before and after 1/2 N (=1/62) of each u/N (u=1, 2, . . . and 30 and N=31) of a 3-RB reference transmission bandwidth.

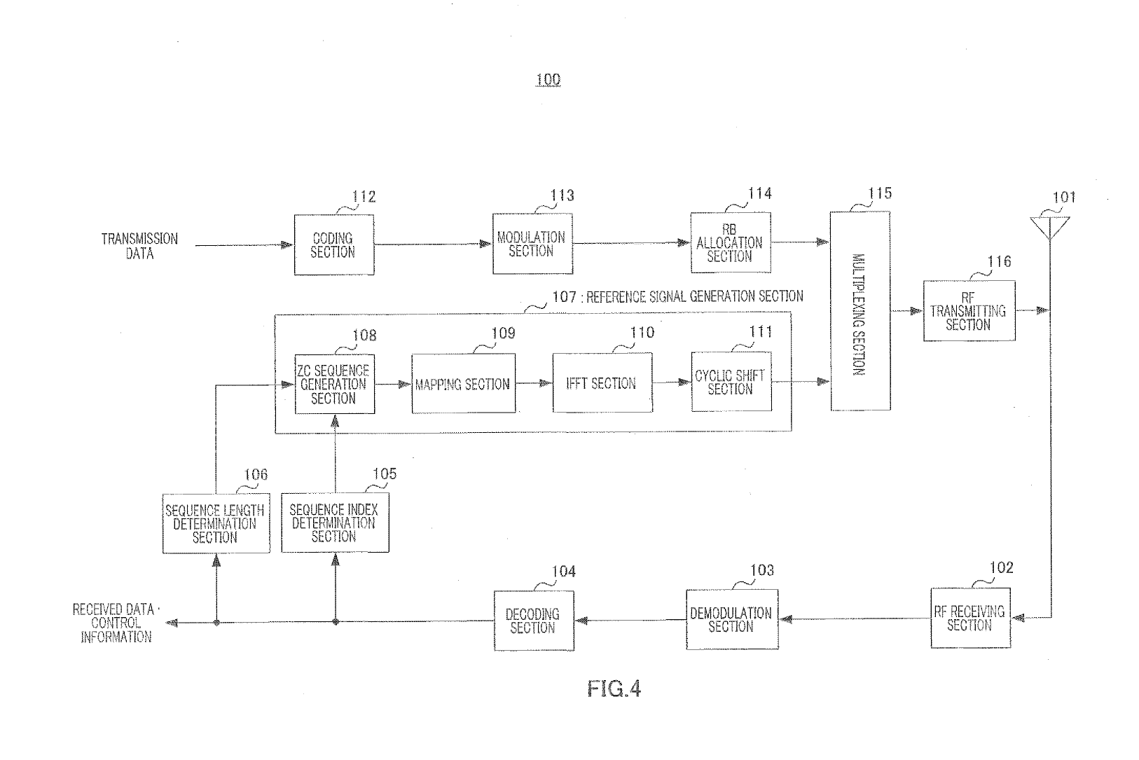

The configuration of terminal 100 according to the present embodiment will be described using FIG. 4.

RF receiving section 102 of terminal 100 shown in FIG. 4 performs receiving processing including down-conversion and A/D conversion on a signal received via antenna 101, and outputs the signal subjected to receiving processing to demodulation section 103.

Demodulation section 103 performs equalization processing and demodulation processing on the signal received as input from RF receiving section 102, and outputs the signal after these processing to decoding section 104.

Decoding section 104 decodes the signal received as input from demodulation section 103, and extracts received data and control information. Then, decoding section 104 outputs the sequence group index among the extracted control information to sequence index determination section 105, and outputs the reference signal transmission bandwidth (i.e. the number of RBs) to sequence index determination section 105 and sequence length determination section 106.

Sequence index determination section 105 has a table in which sequence group indexes of a plurality of sequence groups acquired by grouping into a plurality of different ZC sequences of varying sequence lengths, and the reference signal transmission bandwidths (the number of RBs) are associated with the sequence indexes of ZC sequences, and sequence index determination section 105 determines the sequence indexes of ZC sequences with reference to the table according to the sequence group indexes and the transmission bandwidth (i.e. the number of RBs). Further, the start positions of different sequence indexes are determined at ZC sequences of varying sequence lengths in the table in sequence index determination section 105. Then, sequence index determination section 105 outputs the determined sequence index to ZC sequence generation section 108 in reference signal generation section 107.

Based on the transmission bandwidth (i.e. the number of RBs) received as input from decoding section 104, sequence length determination section 106 determines the sequence length of a ZC sequence. To be more specific, sequence length determination section 106 determines the maximum prime number among the prime numbers smaller than the number of subcarriers equivalent to the transmission bandwidth (i.e. the number of RBs), to be the sequence length of a ZC sequence. Then, sequence length determination section 106 outputs the determined sequence length to ZC sequence generation section 108 in reference signal generation section 107.

Reference signal generation section 107 has ZC sequence generation section 108, mapping section 109, IFFT (Inverse Fast Fourier Transform) section 110 and cyclic shift section 111. Then, reference signal generation section 107 generates as a reference signal a ZC sequence obtained by adding cyclic shift to the ZC sequence generated in ZC sequence generation section 108. Then, reference signal generation section 107 outputs the generated reference signal to multiplexing section 115. Now, the internal configuration of reference signal generation section 107 will be described.

ZC sequence generation section 108 generates a ZC sequence based on the sequence index received as input from sequence index determination section 105 and the sequence length received as input from sequence length determination section 106. Then, ZC sequence generation section 108 outputs the generated ZC sequence to mapping section 109.

Mapping section 109 maps the ZC sequence received as input from ZC sequence generation section 108 to the band corresponding to the transmission bandwidth of terminal 100.

Then, mapping section 109 outputs the mapped ZC sequence to IFFT section 110.

IFFT section 110 performs IFFT processing for the ZC sequence received as input from mapping section 109. Then, IFFT section 110 outputs the ZC sequence after IFFT processing to cyclic shift section 111.

Based on the predetermined amount of cyclic shift, cyclic shift section 111 cyclic-shifts for the ZC sequence received as input from IFFT section 110. Then, cyclic shift section 111 outputs the cyclic-shifted ZC sequence to multiplexing section 115.

Coding section 112 encodes transmission data, and outputs the encoded data to modulation section 113.

Modulation section 113 modulates the encoded data received as input from coding section 112, and outputs the modulated signal to RB allocation section 114.

RB allocation section 114 allocates the modulated signal received as input from modulation section 113 to the band (RB) corresponding to the transmission bandwidth of terminal 100, and outputs the modulated signal allocated to the band (RB) corresponding to the transmission bandwidth of terminal 100 to multiplexing section 115.

Multiplexing section 115 time-multiplexes the transmission data (modulated signal) received as input from RB allocation section 114 and the ZC sequence (reference signal) received as input from cyclic shift section 111 of reference signal generation section 107, and outputs the multiplexed signal to RF transmitting section 116. The multiplexing method in multiplexing section 115 is not limited to time multiplexing, and may be frequency multiplexing, code multiplexing and IQ multiplexing on a complex space.

RF transmitting section 116 performs transmission processing, including D/A conversion, up-conversion and amplification, on the multiplexed signal received as input from multiplexing section 115, and transmits via radio the signal after the transmission processing from antenna 101 to the base station.

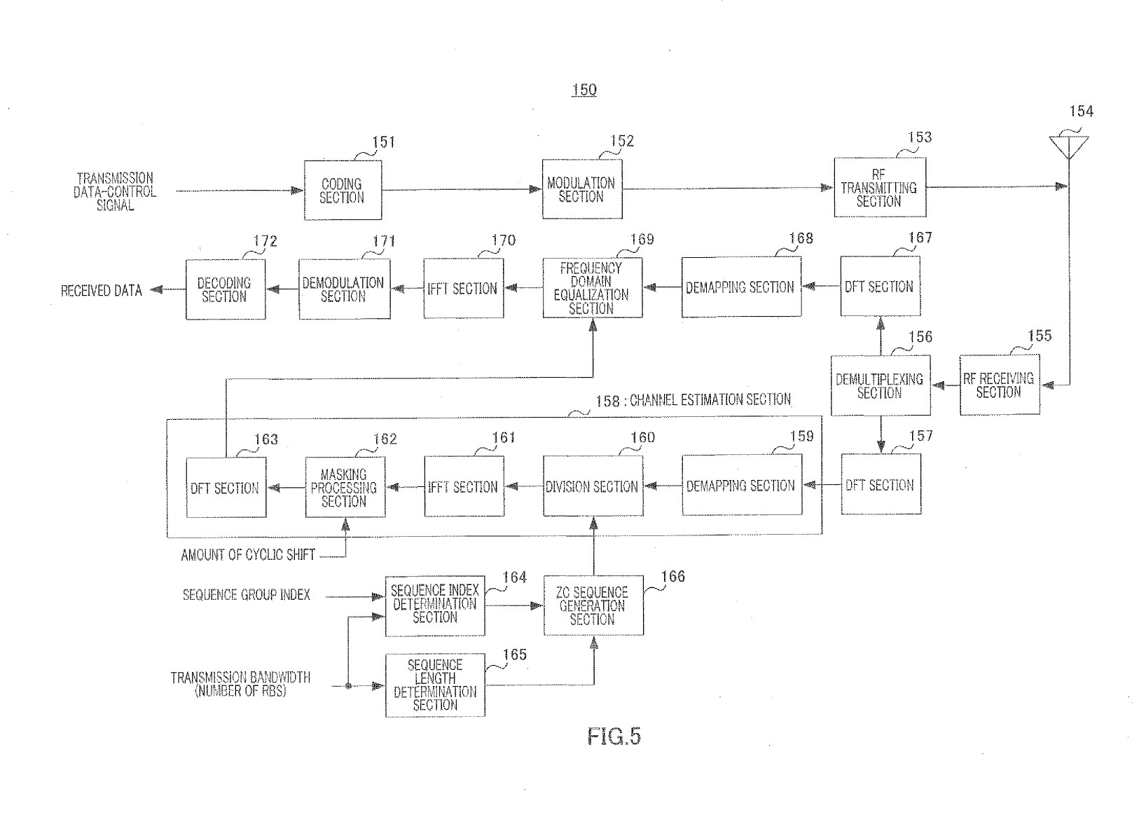

Next, the configuration of base station 150 according to the present embodiment will be explained using FIG. 5.

Coding section 151 in base station 150 shown in FIG. 5 encodes transmission data and a control signal, and outputs the encoded data to modulation section 152. The control signal includes a sequence group index showing the sequence group allocated to base station 150 and the transmission bandwidth (i.e. the number of RBs) of the reference signal transmitted by terminal 100.

Modulation section 152 modulates the coded data received as input from coding section 151, and outputs the modulated signal to RF transmitting section 153.

RF transmitting section 153 performs transmission processing, including D/A conversion, up-conversion and amplification, on the modulated signal, and transmits the signal after the transmission processing via radio from antenna 154.

RF receiving section 155 performs receiving processing, including down-conversion, A/D conversion, on a signal received via antenna 154, and outputs the signal after the receiving processing to demultiplexing section 156.

Demultiplexing section 156 demultiplexes the signal outputted from RF receiving section 155 into the reference signal, data signal and control signal. Demultiplexing section 156 outputs the demultiplexed reference signal to DFT (Discrete Fourier transform) section 157 and outputs the data signal and control signal to DFT section 167.

DFT section 157 performs DFT processing on the reference signal received as input from demultiplexing section 156, to transform the time-domain signal to a frequency-domain signal. DFT section 157 outputs the reference signal transformed into the frequency domain, to demapping section 159 of channel estimation section 158.

Channel estimation section 158, which has demapping section 159, division section 160, IFFT section 161, masking processing section 162 and DFT section 163, estimates channels based on the reference signal outputted from DFT section 157. Now, the internal configuration of channel estimation section 158 will be described specifically.

Demapping section 159 extracts the parts corresponding to the transmission band of each terminal from the signal received as input from DFT section 157. Demapping section 159 outputs the extracted signals to division section 160.

Division section 160 divides the signals received as input from demapping section 159 by ZC sequences received as input from ZC sequence generation section 166 (described later). Then, division section 160 outputs the division results (correlation values) to IFFT section 161.

IFFT section 161 performs IFFT processing on the signals outputted from division section 160. Then, IFFT section 161 outputs the signals after the IFFT processing to masking processing section 162.

Based on the amount of cyclic shift received as input, by masking the signals received as input from IFFT section 161, masking processing section 162 as the extraction means extracts the correlation value in the period (the detection window) where the correlation value of the desired cyclic shift sequence is present. Then, masking processing section 162 outputs the extracted correlation value to DFT section 163.

DFT section 163 performs DFT processing on the correlation value received as input from masking processing section 162. Then, DFT section 163 transforms the correlation value after DFT processing to frequency domain equalization section 169. The signal outputted from DFT section 163 shows frequency fluctuation of the channel (the frequency response of the channel).

Sequence index determination section 164 has the same table as in sequence index determination section 105 (FIG. 4) of terminal 100, that is, a table in which sequence group indexes and transmission bandwidths (i.e. the number of RBs) are associated with the sequence indexes, determines the sequence indexes of ZC sequences with reference to the table according to the sequence group index and the transmission bandwidth (i.e. the number of RBs) received as input. That is, start positions of different sequence indexes are determined at ZC sequences of varying sequence lengths in the table in sequence index determination section 164. Then, sequence index determination section 164 outputs the determined sequence index to ZC sequence generation section 166.

Based on the transmission bandwidth (i.e. based on the number of RBs) received as input, sequence length determination section 165 determines the sequence length of a ZC sequence similar to sequence length determination section 106 of terminal 100 (FIG. 4). Then, sequence length determination section 165 outputs the determined sequence length to ZC sequence generation section 166.

Similar to ZC sequence generation section 108 of terminal 100 (FIG. 4), ZC sequence generation section 166 generates a ZC sequence based on the sequence index received as input from sequence index determination section 164 and the sequence length received as input from sequence length determination section 165. Then, ZC sequence generation section 166 outputs the generated ZC sequence to division section 160 in channel estimation section 158.

Meanwhile, DFT section 167 performs DFT processing on the data signal and the control signal received as input from demultiplexing section 156, to transform the time-domain signal to a frequency-domain signal. DFT section 167 outputs the data signal and control signal transformed into the frequency domain, to demapping section 168.

Demapping section 168 extracts the parts of the data signal and control signal corresponding to the transmission band of each terminal from the signal received as input from DFT section 167,

and outputs the extracted signals to frequency domain equalization section 169.

Frequency domain equalization section 169 performs equalization processing on the data signal and control signal received as input from demapping section 168, using the signal which is received as input from DFT section 163 in channel estimating section 158 (the frequency response of the channel). Frequency domain equalization section 169 outputs the signals subjected to equalization processing to IFFT section 170.

IFFT section 170 performs IFFT processing on the data signal and control signal received as input from frequency domain equalization section 169. IFFT section 170 outputs the signals subjected to IFFT processing to demodulation section 171.

Demodulation section 171 demodulates the signals received as input from IFFT section 170, and outputs the signals subjected to demodulation processing to decoding section 172.

Decoding section 172 decodes the signals received as input from demodulation section 171, and extracts received data.

Next, an example of determining sequence indexes in sequence index determination section 105 of terminal 100 (FIG. 4) and sequence index determination section 164 of base station 150 (FIG. 5) will be explained.

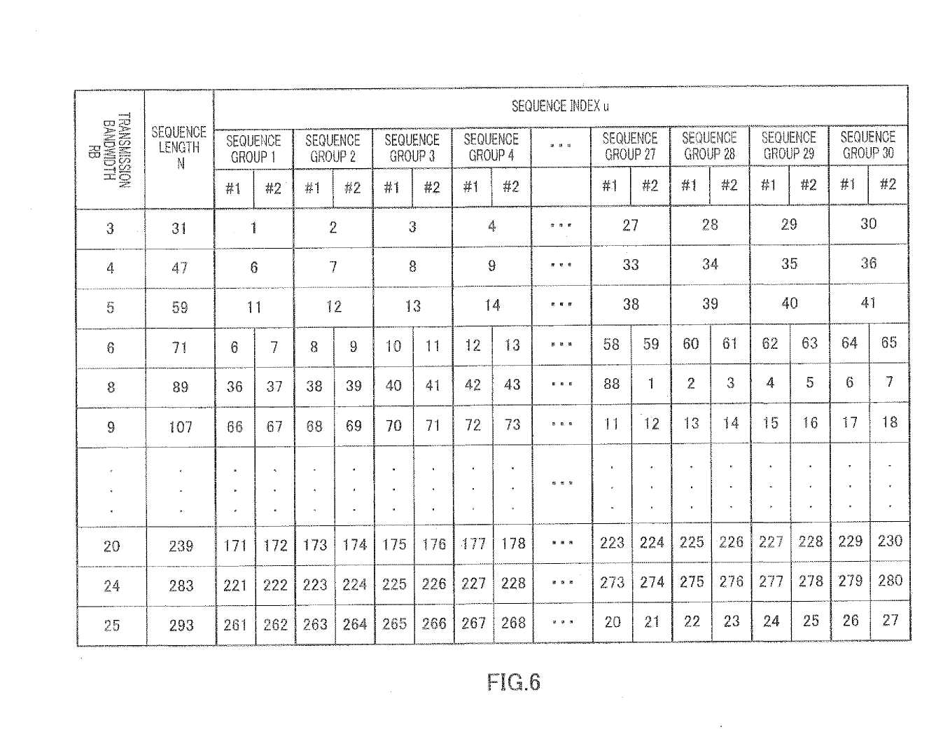

In the following explanation, the number of sequence groups is thirty (sequence groups 1 to 30). Further, as the reference signal transmission bandwidth (i.e. the number of RBs), the number of RBs is equal to or more than 3 RBs and is a multiple of two, three or five. Specifically, as the reference signal transmission bandwidth (i.e. the number of RBs), 3 RBs, 4 RBs, 5 RBs, 6 RBs, 8 RBs, 9 RBs, 10 RBs, 12 RBs, 15 RBs, 16 RBs, 18 RBs, 20 RBs, 24 RBs and 25 RBs are used. Further, 1 RB is formed with 12 subcarriers. Further, sequence length N of a ZC sequence is the maximum prime number equal to or less than the number of subcarriers equivalent to each transmission bandwidth (i.e. to each number of RBs). To be more specific, as shown in FIG. 6, assuming that the sequence length N is 31 in 3 RBs (36 subcarriers), the sequence length N is 47 in 4 RBs (48 subcarriers), and the sequence length N is 59 in 5 RBs (60 subcarriers). The same will apply to a case where the transmission bandwidth (i.e. the number of RBs) is 6 RBs to 25 RBs. Further, the sequence indexes of ZC sequences of each sequence length are assigned in ascending order to sequence groups 1 to 30. Here, one ZC sequence is assigned per one sequence group in transmission bandwidths of 3 RBs to 5 RBs and two ZC sequences are assigned per one sequence group in transmission bandwidths of 6 RBs or more. That is, with transmission bandwidths (i.e. the number of RBs) of 3 RBs to 5 RBs, 30 ZC sequences (=1×30 groups) are used as reference signals in each transmission bandwidth, and with transmission bandwidth of 6 RBs or more, 60 ZC sequences (=2×30 groups) are used as reference signals in each transmission bandwidth. Further, the sequence indexes of ZC sequences used for reference signals are consecutive between maximum sequence index u=N−1 and minimum sequence index u=1. That is, when sequence indexes are assigned in ascending order to sequence groups, the sequence index next to sequence index u=N−1 is sequence index u=1. Further, the table shown in FIG. 6 is held in sequence index determination section 105 and sequence index determination section 164.

With the present embodiment, the start positions of different sequence indexes are determined at ZC sequences of varying sequence lengths. Specifically, by providing different offsets for sequence indexes of ZC sequences of varying sequence lengths and determining the start positions of sequence indexes, the u/N of ZC sequences used for reference signals are dispersed over the entirety from 0 to 1. For example, as shown in FIG. 6, offset=0 is given to ZC sequences of sequence length N=31 associated with 3 RBs of the smallest transmission bandwidth (i.e. the smallest number of RBs), and the start position of a sequence index is determined at sequence index u=1 (=1+0). That is, as shown in FIG. 6, in a 3-RB transmission bandwidth, sequence index u=1 is assigned to sequence group 1, sequence index u=2 is assigned to sequence group 2, and sequence index u=3 is assigned to sequence group 3. The same will apply to sequence group 4 to sequence group 30.

Further, assuming that the offset for ZC sequences of sequence length N=47 associated with a 4-RB transmission bandwidth is 5, the offset for ZC sequences of sequence length N=59 associated with a 5-RB transmission bandwidth is 10, the offset for ZC sequences of sequence length N=71 associated with a 6-RB transmission bandwidth is 5, the offset for ZC sequences of sequence length N=89 associated with an 8-RB transmission bandwidth is 35, the offset for ZC sequences of sequence length N=107 associated with a 9-RB transmission bandwidth is 65 and the offset for ZC sequences of sequence length N=113 associated with a 10-RB transmission bandwidth is 85.

That is, as shown in FIG. 6, the offset=5 is given to ZC sequences of sequence length N=47 associated with the 4-RB transmission bandwidth, and therefore the start position of the ZC sequences used for reference signals is determined at 6 (=1+5). Accordingly, in the 4-RB transmission bandwidth, sequence index u=6 is assigned to sequence group 1, sequence index u=7 is assigned to sequence group 2, and sequence index u=8 is assigned to sequence group 3. The same will apply to sequence group 4 to sequence group 30.

Likewise, as shown in FIG. 6, the offset=10 is given to ZC sequences of sequence length N=59 associated with the 5-RB transmission bandwidth, and therefore the start position of the ZC sequences used for reference signals are determined at 11 (=1+10). Accordingly, in the 5-RB transmission bandwidth, sequence index u=11 is assigned to sequence group 1, sequence index u=12 is assigned to sequence group 2, and sequence index u=13 is assigned to sequence group 3. The same will apply to sequence group 4 to sequence group 30.

Further, as shown in FIG. 6, the offset=5 is given to ZC sequences of sequence length N=71 associated with the 6-RB transmission bandwidth, and therefore the start position of the ZC sequences used for reference signals is determined at 6 (=1+5). Accordingly, in the 6-RB transmission bandwidth, the number of ZC sequences is two per sequence group, so that sequence indexes u=6 and u=7 are assigned to sequence group 1, sequence indexes u=8 and u=9 are assigned to sequence group 2, and sequence indexes u=10 and u=11 are assigned to sequence group 3. The same will apply to sequence group 4 to sequence group 30.

Regarding transmission bandwidths of 8 RBs to 25 RBs, start positions of sequence indexes are determined in the same way.

It is preferable that different offsets are set between consecutive transmission bandwidths (i.e. the consecutive numbers of RBs). For example, between consecutive transmission bandwidths (i.e. the consecutive number of RBs) like a 4-RB transmission bandwidth and a 5-RB transmission bandwidth, their offsets are made different as 5 and 10.

Further, offsets given to sequence indexes may be set up in order from the ZC sequences of a sequence length associated with a smaller transmission bandwidth (i.e. the smaller number of RBs), for example. The offset in a 4-RB transmission bandwidth may be set up based on the offset given to a 3-RB transmission bandwidth, the offset in a 5-RB transmission bandwidth may be set up based on the offsets given to the 3-RB transmission bandwidth and the 4-RB transmission bandwidth, and the offset in a 6-RB transmission bandwidth may be set up based on the offsets given to the 3-RB transmission bandwidth, the 4-RB transmission bandwidth, and the 5-RB transmission bandwidth.

Sequence index determination section 105 of terminal 100 (FIG. 4) and sequence index determination section 164 of base station 150 (FIG. 5) have a table in which sequence indexes of ZC sequences used for reference signals as described above and which is shown in FIG. 6, determines sequence indexes u based on sequence group indexes and transmission bandwidths (i.e. the number of RBs). If sequence group 2 is assigned to base station 150 and if the reference signal transmission bandwidth transmitted by terminal 100 belonging to base station 150, sequence index determination section 105 of terminal 100 (FIG. 4) and sequence index determination section 164 of base station 150 (FIG. 5) output sequence index u=12 associated with a 5 RB transmission bandwidth and sequence group 2 with reference to the table shown in FIG. 6.

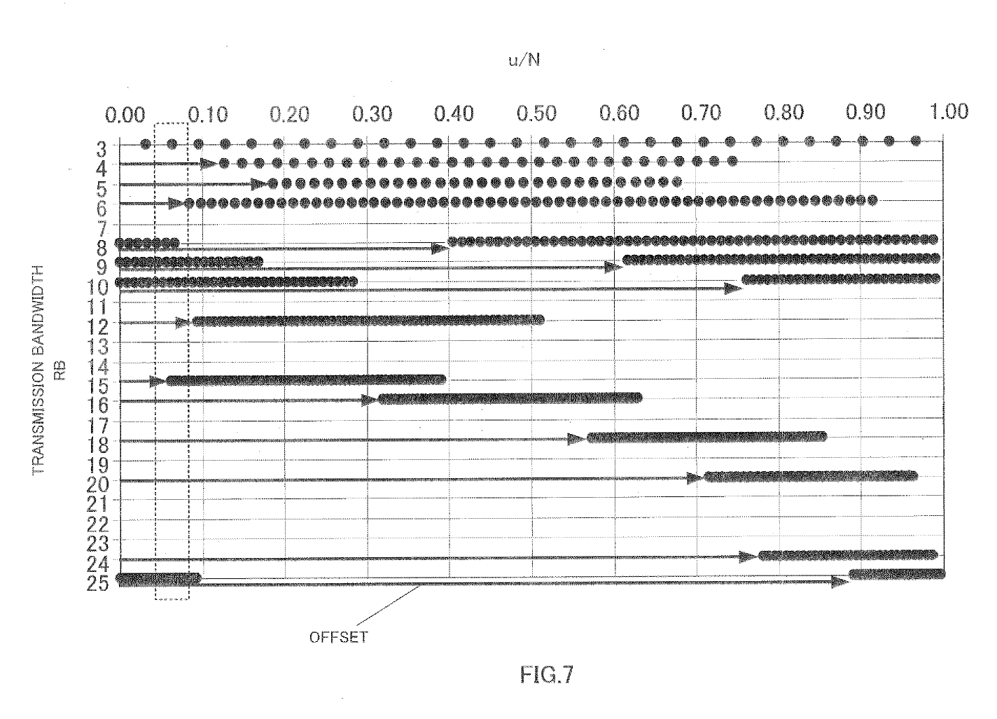

Next, FIG. 7 shows the distribution of u/N of the ZC sequences used for reference signals (i.e. ZC sequences assigned in the table shown in FIG. 6).

For example, the offset of sequence indexes in the 4-RB transmission bandwidth is 5, and start sequence index u of the ZC sequence of sequence length N=47 is 6, so that the u/N at the head of the 4-RB transmission bandwidth shown in FIG. 7 u/N=6/47=0.13. Accordingly, as shown in FIG. 7, with the 4-RB transmission bandwidth, the u/N of 30 ZC sequences are distributed at intervals of 1/N (=1/47), from u/N=6/47. That is, with the 4-RB transmission bandwidth, the offset of the u/N=5/47=0.11 solid arrow shown in FIG. 7) is given. Likewise, with the 5-RB transmission bandwidth, the offset of the u/N=10/59=0.19 is given, and with the 6-RB transmission bandwidth, the offset of the u/N=5/71=0.08 is given. The same will apply to transmission bandwidths of 8 RBs to 25 RBs.

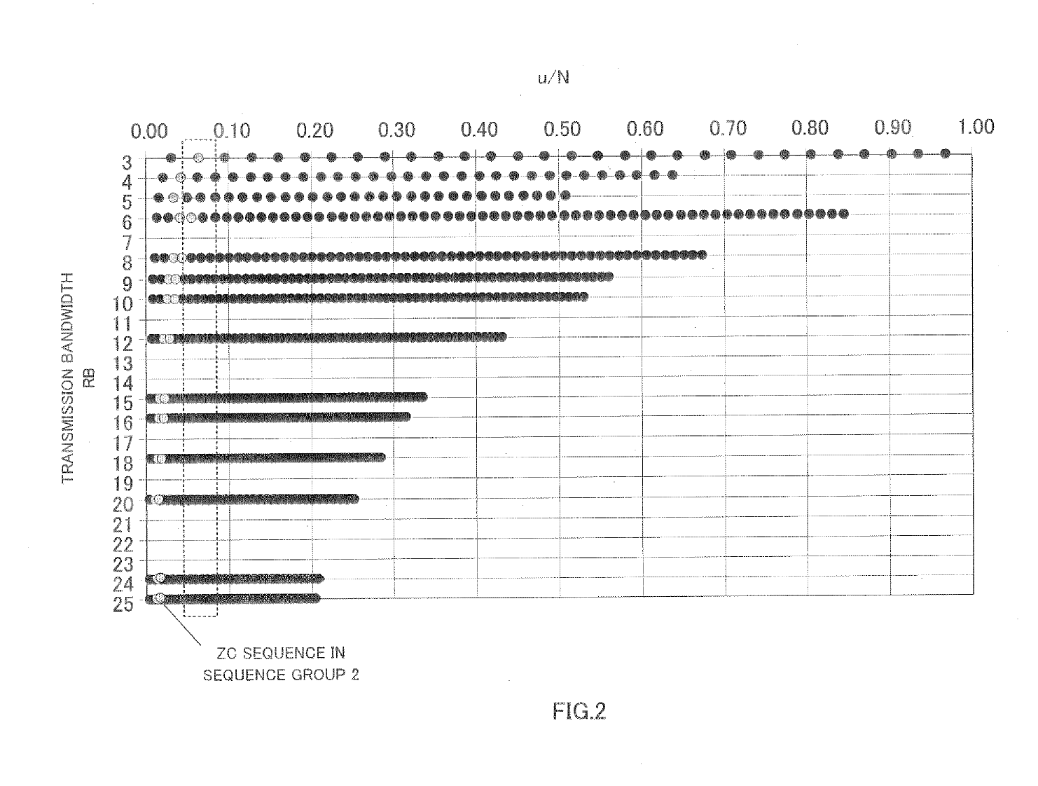

Here, the distribution of u/N in FIG. 2 and the distribution of u/N in FIG. 7 are compared. Although, in the distribution of u/N shown in FIG. 2, u/N tend to be near 0 when a transmission bandwidth (i.e. the number of RBs) as described above is wider, the distribution of u/N shown in FIG. 7 is dispersed over the entirety from 0 to 1 over different transmission bandwidths (3 RBs to 25 RBs). For this reason, with regards to ZC sequences showing u/N close to zero, the difference in u/N between ZC sequences of different transmission bandwidths (different sequence lengths) is less likely to be close to 0. For example, with reference to the second ZC sequence from the head of a 3-RB transmission bandwidth, the number of ZC sequences included in a range where difference in u/N from that ZC sequence is within 0.02 (the dotted frame shown in FIG. 7), is smaller than as in a case of FIG. 2. By this means, the difference in u/N between ZC sequences of different transmission bandwidths (different sequence lengths) is less likely to be close to 0, and inter-sequence interference between cells is less likely to occur.

A criterion for the dispersion of u/N is that one or more ranges of ZC sequences used for reference signals in transmission bandwidths of 4 RBs or more in the range of before and after 1/2 N (=1/62) of each u/N (N=31 and u=1, 2, . . . and 30) of a 3-RB reference transmission bandwidth. Here, the range of ZC sequences used for reference signals includes from the sequence index of the head ZC sequence to the sequence index of the tail ZC sequence used for reference signals in each RB, and part of the ZC sequences may be included in the range before and after 1/2 N (=1/62) of each u/N (N=31 and u=1, 2, . . . and 30) of a 3-RB reference transmission bandwidth.

All 30 sequences that can be generated are used in a 3-RB reference transmission bandwidth, and u/N are distributed over the entirety from 0 to 1 at regular intervals. Accordingly, in ZC sequences of transmission bandwidths of 4 RBs or more, sequence indexes having u/N near u/N (in the range of ½ N) of a 3-RB reference transmission bandwidth are used as reference signals, so that u/N can be dispersed from 0 to 1 all over the transmission bandwidths. Even when the transmission bandwidths are equal to or more than 4 RBs, a transmission bandwidth (i.e. the number of RBs) in which the range of ZC sequences used for reference signals is all sequences, is not included in the definition of transmission bandwidths equal to or more than 4 RBs.

Further, a criterion for the dispersion may be the proportion between sequence indexes u of ZC sequences in a 3-RB reference transmission bandwidth (sequence length N=31) and the number of ZC sequences in other transmission bandwidths included in the range before and after 1/2 N (=1/62) of u/N. For example, the proportion of the number of above ZC sequences to ZC sequences in a 3-RB reference transmission bandwidth may be a predetermined rate or less (e.g. 50% or less). By this means, the ZC sequences in transmission bandwidths (i.e. the number of RBs) used for reference signals are dispersed near ZC sequences in a reference 3-RB transmission bandwidth (sequence length N=31), that is, u/N are dispersed over the entirety from 0 to 1.

In this way, according to the present embodiment, the start positions of different sequence indexes are determined in ranges of ZC sequences having varying sequence lengths and used for reference signals. Further, stating positions are determined such that one or more ranges of ZC sequences used for reference signals in transmission bandwidths of 4 RBs or more are included in the range before and after 1/2 N (=1/62) of each u/N (N=31 and u=1, 2, . . . and 30) of a 3-RB reference transmission bandwidth. By this means, in different transmission bandwidths (different sequence lengths), it is possible to disperse u/N of ZC sequences used for reference signals over the entirety from 0 to 1. Accordingly, even when u/N of ZC sequences are close to zero, the difference in u/N between ZC sequences of different transmission bandwidths in different sequence groups is less likely to be close to 0. Therefore, according to the present embodiment, it is possible to reduce the occurrence of inter-sequence interference between cells to which different sequence groups are assigned. In addition, with the present embodiment, offsets are only set up, so that it is possible to reduce the occurrence of inter-sequence interference between cells without increasing the amount of calculation.

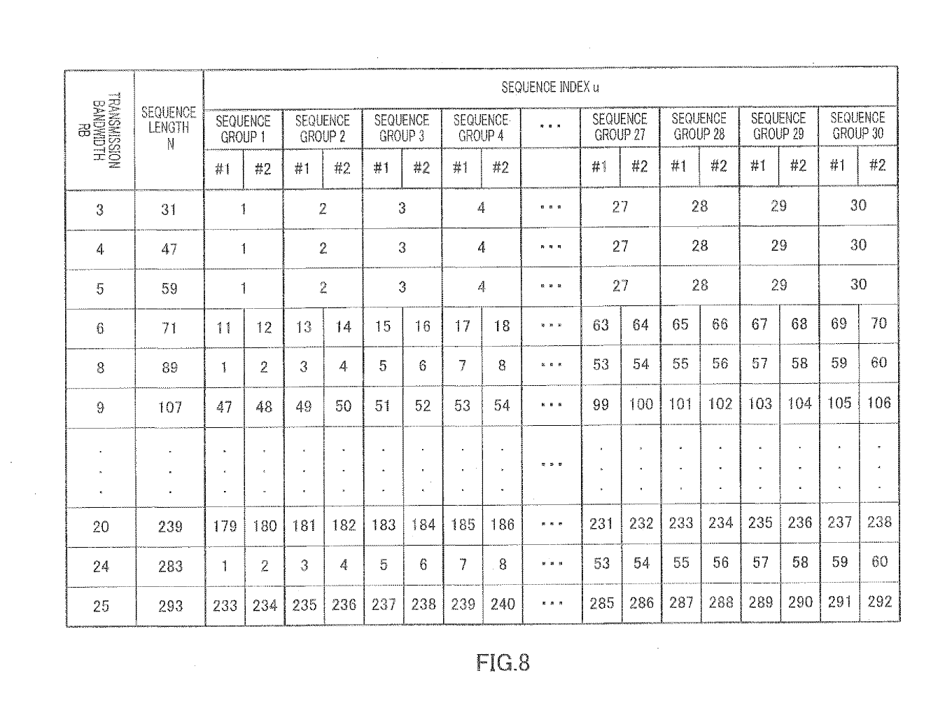

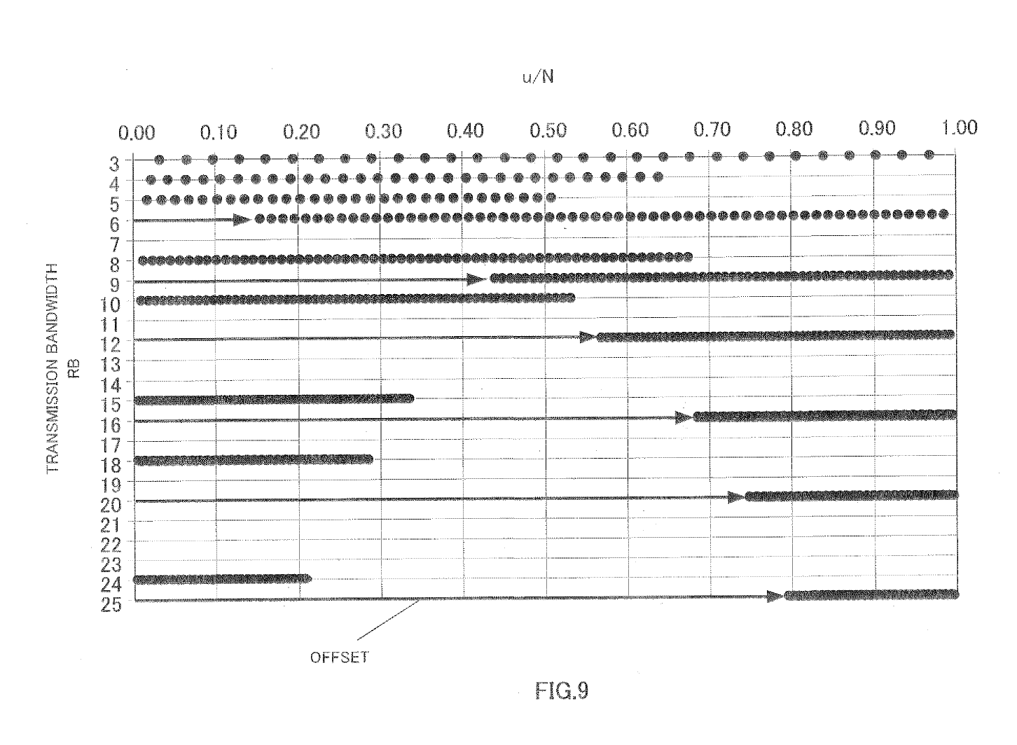

Although a case has been explained with the present embodiment where the table shown in FIG. 6 is used, a table that can be used for the present invention is not limited to the table shown in FIG. 6. For example, the table shown in FIG. 8 may be used. In the table shown in FIG. 8, for example, offset 0 is given to the sequence indexes for the 5-RB transmission bandwidth, offset 10 is given to the sequence indexes for the 6-RB transmission bandwidth, offset 0 is given to the sequence indexes for the 8-RB transmission bandwidth, and offset 46 is given to the sequence indexes for the 9-RB transmission bandwidth. That is, sequence indexes u=1 to 30 are used for reference signals among ZC sequences of sequence length 59 (sequence indexes u=1 to 58) in the 5-RB transmission bandwidth, and, in contrast, sequence indexes u=11 to 70 are used for reference signals among ZC sequences of sequence length 71 (sequence indexes u=1 to 70) in the 6-RB transmission bandwidth. Likewise, although sequence indexes u=1 to 60 are used for reference signals among ZC sequences of sequence length 89 (sequence indexes u=1 to 88) in the 8-RB transmission bandwidth, and, in contrast, sequence indexes u=47 to 106 are used for reference signals among ZC sequences of sequence length 107 (sequence indexes u=1 to 106) in the 9-RB transmission bandwidth. That is, in a given transmission bandwidth (5 RBs, 8 RBs, . . . and 24 RBs shown in FIG. 8), the start position of sequence indexes of ZC sequences used for reference signals is determined at u=1 of the head. By contrast with this, with other transmission bandwidths (6 RBs, 9 RBs, . . . , 20 RBs and 25 RBs shown in FIG. 8), the start position of a sequence index is determined such that the tail of the sequence indexes of ZC sequences used for a reference signal is the maximum sequence index among those ZC sequences (i.e. the sequence index u=N−1 of ZC sequence of sequence length N). By this means, as shown in FIG. 9, transmission bandwidths are dispersed to the transmission bandwidths in which u/N of ZC sequences are near 0 and transmission bandwidths in which u/N of ZC sequences are near 1. Therefore, similar to the present embodiment, it is possible to satisfy the above-described criterion for the dispersion of u/N and distribute the u/N between 0 and 1 in a dispersed manner.

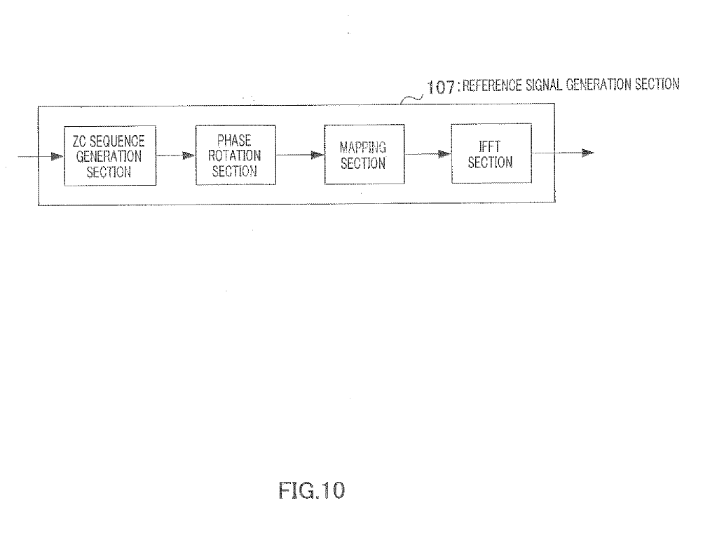

Further, although a case has been explained with the present embodiment where reference signal generation section 107 in terminal 100 is shown in FIG. 4, the section may be configured as shown in FIG. 10. Reference signal generation section 107 shown in FIG. 10 has the phase rotation section instead of the cyclic shift section before the IFFT section. This phase rotation section performs phase rotation as equivalent frequency-domain processing instead of cyclic-shifting in the time domain. That is, the amounts of phase rotation corresponding to the amounts of cyclic shift are assigned to subcarriers. These configurations make it possible to reduce inter-sequence interference.

Further, although a case has been explained with the present embodiment where a frequency-domain ZC sequence (equation 3) is generated, it is equally possible to generate a time-domain ZC sequence (equation 1) and then perform DFT processing.

Further, although a case has been explained where sequence indexes of ZC sequences of each sequence length are assigned in ascending order to sequence groups 1 to 30, the present invention is not limited to this. For example, the range of sequence indexes used for reference signals is determined from the sequence index of the head ZC sequence to the sequence index of the tail ZC sequence used for reference signals in each RB, and sequence indexes in a range of sequence indexes used as reference signals may be assigned to sequence groups 1 to 30 on a random basis or may be assigned based on rules.

### Embodiment 2

As described in Embodiment 1, when the start positions of different sequence indexes are only determined at ZC sequences of varying sequence lengths among ZC sequences used for reference signals, as shown in FIG. 7, while u/N are dispersed over the entirety from 0 to 1, the u/N are not distributed uniformly. By this means, each sequence group is likely to receive various inter-sequence interference from other sequence groups.

As described above, cross-correlation increases when the difference in u/N between ZC sequences in different transmission bandwidths (i.e. the different number of RBs) that is, the difference in u/N between ZC sequences of varying sequence lengths, is close to 0, cross-correlation increases. Accordingly, it is necessary to determine start positions of sequence indexes showing the reliability of receiving inter-sequence interference between sequence groups uniform.

Then, with the present embodiment, between neighboring transmission bandwidths (i.e. between neighboring number of RBs), the start position of sequence indexes of ZC sequences used for reference signals in one transmission bandwidth (i.e. in one number of RBs) is the sequence index having the value near u/N of the tail ZC sequence in the other transmission bandwidth (i.e. in the other number of RBs).

Now, an example of determining sequence indexes in sequence index determination section 105 of terminal 100 (FIG. 4) and sequence index determination section 164 in base station 150 (FIG. 5) of the present embodiment will be explained. In the following explanation, the same transmission bandwidths (i.e. the same number of RBs), sequence lengths N and sequence groups are used as transmission bandwidths (i.e. the number of RBs), sequence lengths N and sequence groups shown in FIG. 6 of Embodiment 1.

With the table sequence index in determination section 105 and sequence index determination section 164, between neighboring transmission bandwidths (i.e. between neighboring number of RBs), the start position of ZC sequences used for reference signals in one transmission bandwidth (i.e. in one number of RBs) is determined to be a greater value than the u/N of the tail ZC sequence in the other transmission bandwidth (i.e. the other number of RBs) and, is determined at the sequence index having the closest value to that u/N.

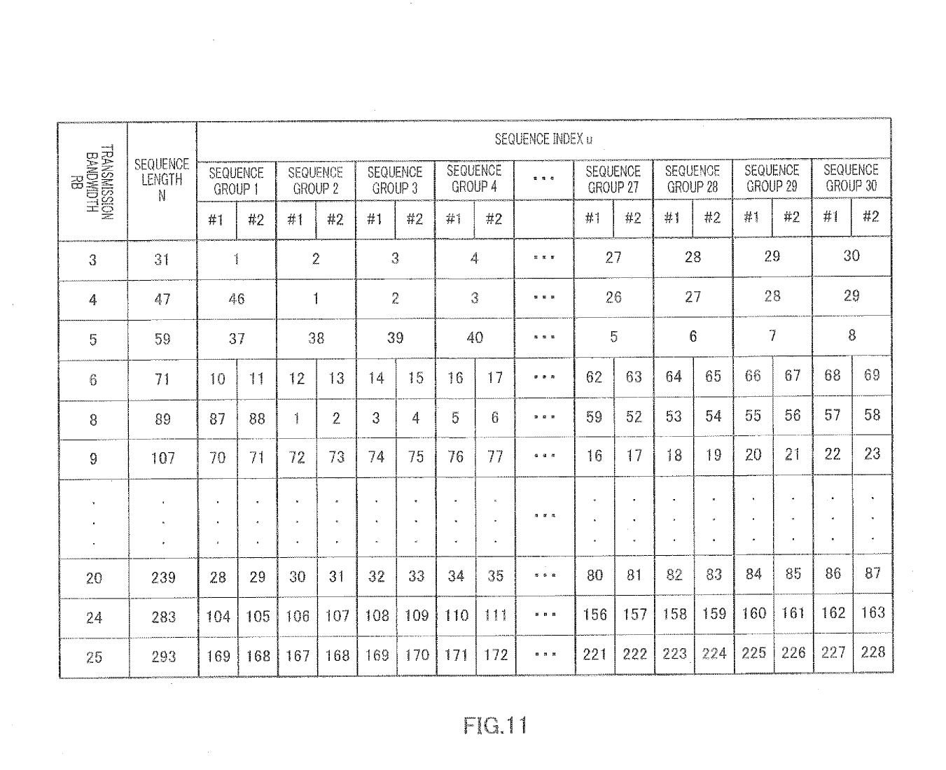

For example, offsets (45, 36, 9, 86, 69, 24 and . . . ) are given to sequence indexes for transmission bandwidths (e.g. 4 RBs, 5 RBs, 6 RBs, 8 RBs, 9 RBs, 10 RBs and . . . ). That is, as shown in FIG. 11, as ZC sequences used for reference signals, sequence indexes u=1 to 30 are assigned to a 3-RB transmission bandwidth, and, in contrast, sequence indexes u=46 (=1+45) and 1 to 29 are assigned to a 4-RB transmission bandwidth. Likewise, as shown in FIG. 11, as ZC sequences used for reference signals, sequence indexes u=37 (=1+36) to 58 and 1 to 8 are assigned to a 5-RB transmission bandwidth, sequence indexes u=10 (=1+9) to 69 are assigned to a 6-RB transmission bandwidth, sequence indexes u=87 (=1+86), 88 and 1 to 58 are assigned to an 8-RB transmission bandwidth, sequence indexes u=70 (=1+69) to 106 and 1 to 23 are assigned to a 9-RB transmission bandwidth and sequence indexes u=25 (=1+24) to 84 are assigned to a 10-RB transmission bandwidth. The same will apply to transmission bandwidths of 12 RBs to 25 RBs.

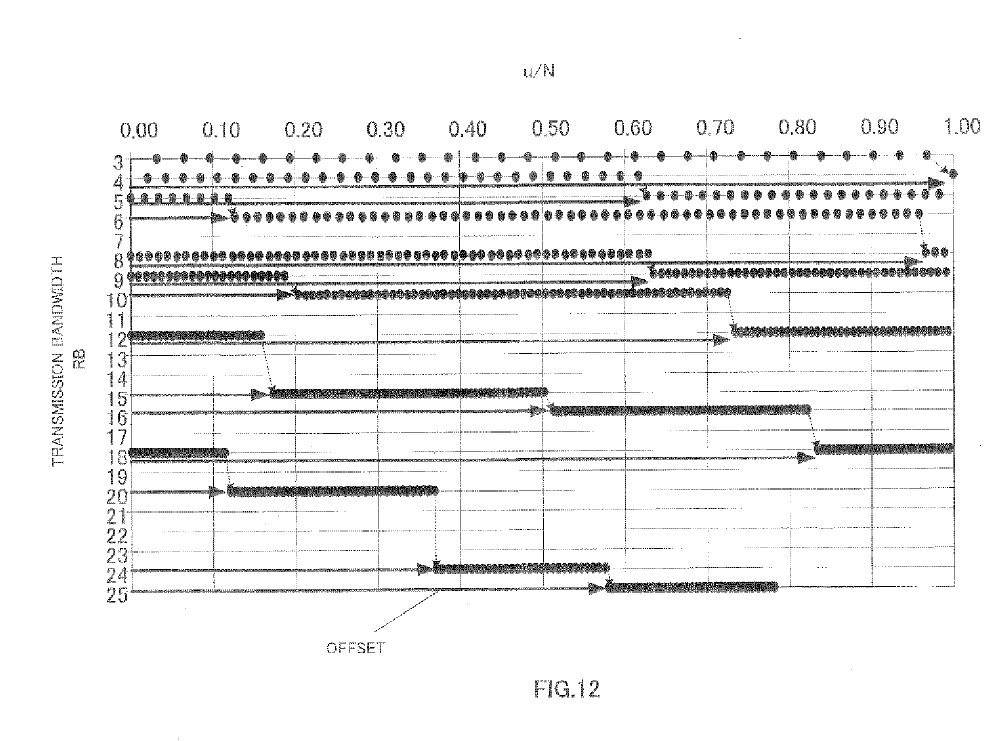

Here, FIG. 12 shows the distribution of u/N of the ZC sequences used for reference signals (i.e. ZC sequences determined in the table shown in FIG. 11). As shown in FIG. 12, in the 3-RB transmission bandwidth, the u/N of ZC sequences used for reference signals are from 0.03 to 0.97. Further, in the 4-RB transmission bandwidth, u/N of ZC sequences used for reference signals are 0.98 and from 0.02 to 0.62. That is, with the 4-RB transmission bandwidth, the start position of sequence indexes is determined to be greater than the u/N (0.97) of the tail ZC sequence (sequence index u=30) in the 3-RB transmission bandwidth neighboring the 4-RB transmission bandwidth and is determined to be sequence index 46 having the closest u/N (=0.98).

Likewise, in the 5-RB transmission bandwidth, the u/N of ZC sequences used for reference signals ranges from 0.63 to 0.98 and from 0.02 to 0.14. That is, with the 5-RB transmission bandwidth, the start position of sequence indexes is determined to be greater than the u/N (=0.62) of the tail ZC sequence (sequence index u=29) in the 4-RB transmission bandwidth neighboring the 5-RB transmission bandwidth and is determined to be sequence index 37 having the closest u/N (=0.63). The same will apply to transmission bandwidths of 6 RBs to 25 RBs.

In this way, from the sequence index of the head ZC sequence in the 3-RB transmission bandwidth to the sequence index of the tail ZC sequence in the 25-RB transmission bandwidth with the table shown in FIG. 11 are determined such that the u/N are distributed in ascending order from 0 to 1 (see a dotted arrow shown in FIG. 12). However, u/N=0 to 1 are subject to cyclic shift and the next of u/N=1.0 is u/N=0. That is, the start positions of sequence indexes are set such that u/N are distributed in an ascending order from 0 to 1 over transmission bandwidths of 3 RBs to 25 RBs. Further, when u/N=1, the start position of sequence indexes is determined from u/N=0 again in ascending order. By this means, the u/N of a plurality of ZC sequences of transmission bandwidths of 3 RBs to 25 RBs are distributed relatively in a uniform manner between 0 and 1. Accordingly, it is possible to reduce the number of overlapping u/N of ZC sequences of different transmission bandwidths (i.e. different number of RBs), that is, it is possible to reduce the number of differences between u/N of different transmission bandwidths (different number of RBs) close to zero.

Further, an interval of u/N between ZC sequences of the same sequence lengths having neighboring sequence indexes is narrower when a transmission bandwidth (i.e. the number of RBs) is wider. That is, a range of u/N of ZC sequences of the same sequence length is narrower when a transmission bandwidth (i.e. the number of RBs) is wider. Accordingly, for example, as shown in FIG. 12, with wide transmission bandwidths of 18 RBs to 25 RBs, u/Ns do not overlap between different transmission bandwidths (i.e. between different number of RBs). Therefore, with 18 RBs to 25 RBs, inter-sequence interference between ZC sequences of sequence lengths associated with different transmission bandwidths does not occur.

In this way, according to the present embodiment, between neighboring transmission bandwidths (between neighboring number of RBs), the start position of sequence indexes of ZC sequences used for reference signals in one transmission bandwidth (i.e. in one number of RBs) is determined to be a greater value than the u/N of the tail ZC sequence in the other transmission bandwidth (i.e. the other number of RBs) and, is determined at the sequence index showing the closest value to that u/N. By this means, the u/N of ZC sequences used for reference signals can be dispersed uniformly between 0 and 1, so that it is possible to minimize inter-sequence interference between cells.

Although a case has been explained with the present embodiment where the present invention is applicable to transmission bandwidths of 3 RBs to 25 RBs,

the present invention is not necessarily applicable to all transmission bandwidths, and transmission bandwidths are grouped into a group of transmission bandwidths of 3 RBs to 15 RBs and a group of transmission bandwidths of 16 RBs to 25 RBs, and the present invention may be applicable to individual groups.

Further, the present invention is not necessarily applicable to all transmission bandwidths and may be applicable to part of transmission bandwidths. For example, among transmission bandwidths of 3 RBs to 25 RBs, the present embodiment is not applicable from 3 RBs to 15 RBs in which the u/N are relatively dispersed, and may be applicable to transmission bandwidths from 16 RBs to 25 RBs in which part of u/N are likely to be gathered.

Further, although a case has been explained with the present embodiment where the start position of sequence indexes is determined to be greater than the u/N of the tail ZC sequence in the neighboring transmission bandwidth and is determined to be a sequence index having the closest value to the u/N,

according to the present invention, the start position of sequence indexes may be a sequence index having the value near u/N of the tail ZC sequence in the neighboring transmission bandwidth. Specifically, the start position may range before and after 1/2 N of the u/N of the tail ZC sequence in the neighboring transmission bandwidth, as near u/N of the tail ZC sequence among ZC sequences. By this means, as in the present embodiment, u/N of ZC sequences used for reference signals are distributed between 0 and 1 relatively in a uniform manner, so that the same advantage is provided to the present embodiment.

### Embodiment 3

When the start positions of different sequence indexes are determined at ZC sequences of varying sequence lengths as in Embodiment 1, it is necessary to store the number of subcarriers associated with reference signal transmission bandwidths (i.e. the number of RBs). For example, with a 4-RB transmission bandwidth (48 subcarriers), it is necessary to take into account that the starting position of the sequence index “48” is determined at maximum, and, in contrast, with a 25-RB transmission bandwidth (300 subcarriers), it is necessary to take into account that the starting position of the sequence index “300” is determined at maximum. That is, the amount of information (the amount of memory) for storing start positions increases when reference signal transmission bandwidths are greater.

Then, with the present embodiment, the start position of sequence indexes of ZC sequences used for reference signals is one of the sequence indexes of a plurality of ZC sequences located at the heads of a plurality of ranges obtained by dividing ZC sequences of each sequence length.

Now, an example of determining sequence indexes in sequence index determination section 105 of terminal 100 (FIG. 4) and sequence index determination section 164 of base station 150 (FIG. 5) will be explained.

In the following explanation, the same transmission bandwidths (i.e. the same number of RBs), sequence lengths N and sequence groups are used as transmission bandwidths (i.e. the number of RBs), sequence lengths N and sequence groups shown in FIG. 6 of Embodiment 1. The number of divisions of ZC sequences of each sequence length is ten. The offset given to sequence indexes of ZC sequences of sequence length N associated with each transmission bandwidth (i.e. each number of RBs) is calculated from floor (the number of sequences (N−1)/the number of divisions×information reduction offset). Here, floor(x) means to truncate after the decimal point of x. Further, information reduction offset is the same value as the number of divisions, and, here, the information reduction offset assumes values from 0 to 9. Then, different information reduction offsets are set up for ZC sequences of varying sequence lengths.

For example, information reduction offsets of transmission bandwidths (4 RBs, 5 RBs, 6 RBs, 8 RBs, 9 RBs and . . . ) are (1, 1, 0, 4, 6 and . . . ). Accordingly, the offset given to sequence indexes is 4 derived from floor (47/10×1) in the 4-RB transmission bandwidth. Likewise, the offset given to sequence indexes is 5 derived from floor (59/10×1) in the 5-RB transmission bandwidth, offsets given to sequence indexes are 0 derived from floor (71/10×0) in the 6-RB transmission bandwidth, the offset given to sequence indexes is 35 derived from floor (89/10×4) in the 8-RB transmission bandwidth, and, the offset given to sequence indexes is 64 derived from floor (107/10×6) in the 9-RB transmission bandwidth.

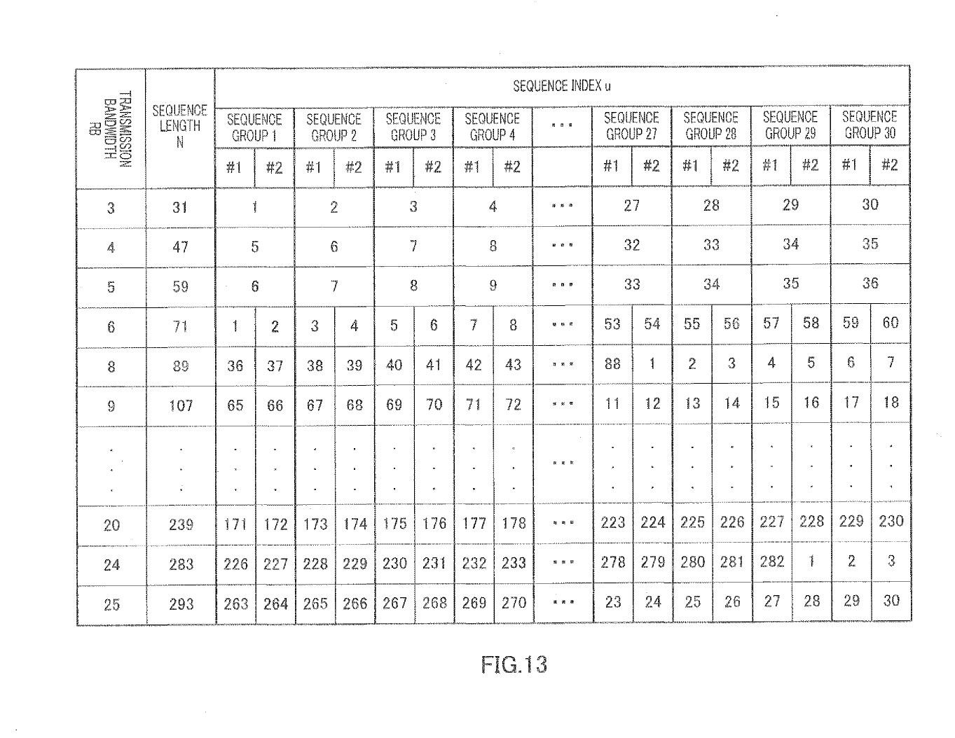

By this means, as shown in FIG. 13, in the 4-RB transmission bandwidth, the start position of sequence indexes is determined at sequence index u=5 (=1+4), and ZC sequences of sequence indexes u=5 to 35 are assigned as ZC sequences used for reference signals. Further, in the 5-RB transmission bandwidth, the start position of sequence indexes is determined at sequence index u=6 (=1+5), and ZC sequences of sequence indexes u=5 to 35 are assigned as ZC sequences used for reference signals. Likewise, in the 6-RB transmission bandwidth, the start position of sequence indexes is determined at sequence index u=1 (=1+0), and ZC sequences of sequence indexes u=1 to 60 are assigned as ZC sequences used for reference signals. The same will apply to transmission bandwidths of 8 RBs to 25 RBs.

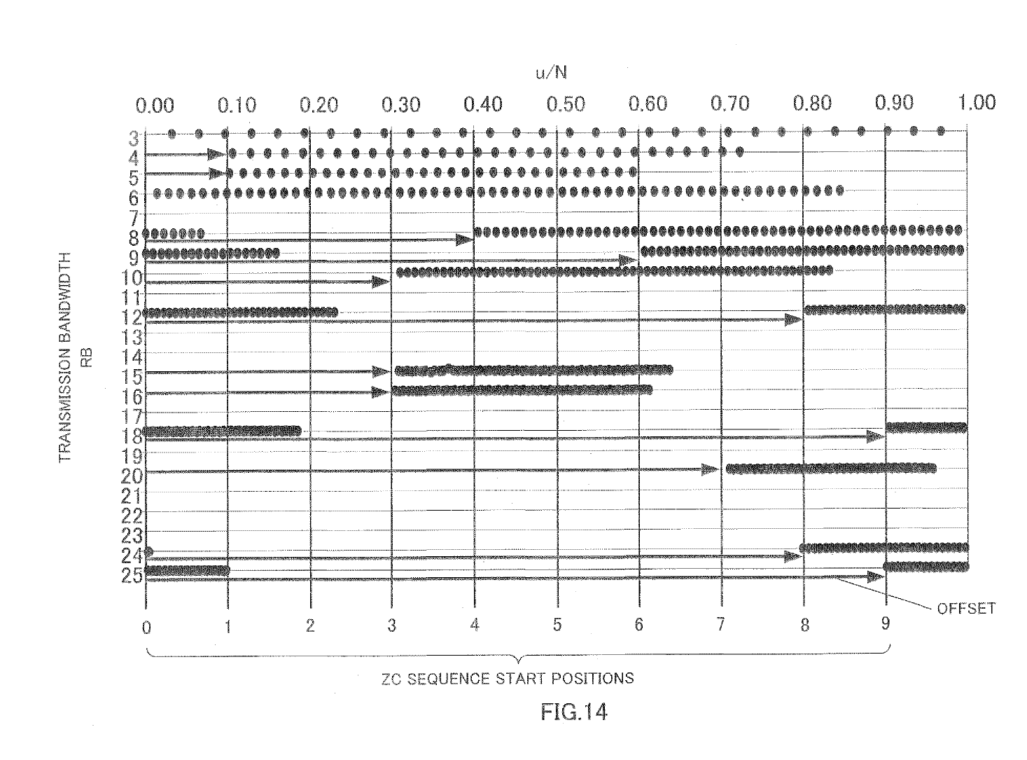

Here, FIG. 14 shows the distribution of u/N of the ZC sequences used for reference signals (i.e. ZC sequences determined in the table shown in FIG. 13). As shown in FIG. 14, the u/N are divided into ten ranges in a range from 0 to 1. That is, the u/N of ZC sequences are equally divided, a plurality of sequence indexes associated with the equally divided u/N are offset candidates, and the start position of ZC sequences used for reference signals is one of those offset candidates. Accordingly, the start position of the u/N (minimum value of u/N) of sequence indexes of ZC sequences used for reference signals in transmission bandwidths of 4 RBs to 25 RBs is one of the head positions of the divided ranges (start positions 0 to 9 shown in FIG. 14). Further, information reduction offsets 0 to 9 are associated with start positions 0 to 9 of ZC sequences shown in FIG. 14. For example, the information reduction offset of the 8-RB transmission bandwidth is 4, so that the u/N of the head ZC sequence used for a reference signal in the 8-RB transmission bandwidth is 0.404 near start position 4 (u/N=0.4) as shown in FIG. 14. Further, the information reduction offset of the 9-RB transmission bandwidth is 6, so that the u/N of the head ZC sequence used for a reference signal in the 9-RB transmission bandwidth is 0.61 near start position 6 (u/N=0.6) as shown in FIG. 14.

In this way, one of the start positions shown in FIG. 14 is assigned to ZC sequences used for reference signals of different transmission bandwidths, that is, ZC sequences of varying sequence lengths. That is, the u/N of the head ZC sequence among ZC sequences of varying sequence lengths is one of 0, 0.1, 0.2, . . . and 0.9. Therefore, it is possible to distribute u/N of ZC sequences of varying sequence lengths over the entirety from 0 to 1 in a dispersed manner as in Embodiment 1. Further, the start positions of sequence indexes are determined by the number of divisions (ten according to the present embodiment). That is, in each transmission bandwidth (i.e. each number of RBs), one of the ten start positions of ZC sequences is determined, so that the amount of information required to store is constant regardless of an increase or decrease of transmission bandwidths (i.e. the number of RBs).

In this way, the present embodiment provides an advantage of reducing the amount of memory for storing the start positions of sequence indexes of ZC sequences while obtaining the same advantage as in Embodiment 1.

Although a case has been explained with the present embodiment where floor(x) is used to calculate offsets given to sequence indexes, the present invention is not limited to floor(x), and, for example, ceil(x) and round(x) may be used. Here, ceil(x) means to round up after the decimal point of x and round(x) means to round off after the decimal point of x.

Embodiments of the present invention have been explained.

Although cases have been explained with the above embodiments where RBs of a multiple of two, three or five are used in reference signal transmission bandwidths, the present invention is not limited to use RBs of a multiple of two, three or five in reference signal transmission bandwidths.

Further, although cases have been explained with the above embodiments where the start positions of different sequence indexes are determined at ZC sequences of varying sequence lengths among ZC sequences used for reference signals, according to the present invention, it is equally possible to determine the start positions of different sequence indexes to ZC sequences of varying sequence lengths among ZC sequences not used for reference signals, that is, among ZC sequences other than ZC sequences used for reference signals.

Further, although cases have been explained with the above embodiments where ZC sequences in one range where sequence indexes u are consecutive from the head of the sequence index to the tail of the sequence index of ZC sequences used for reference signals in each transmission bandwidth (i.e. in each number of RBs), are used as reference signals, with the present invention, when one sequence group has a plurality of ZC sequences used for reference signals in each transmission bandwidth (i.e. in each number of RBs) (transmission bandwidths of 6 RBs or more in the above embodiments), the range of ZC sequences to use for reference signals may be dispersed in a plurality of ranges, and the ZC sequences may be assigned to individual ranges. Specifically, assuming that thirty consecutive sequence indexes are included in the range of ZC sequences to use for one reference signals and thirty consecutive sequence indexes are included in the range of ZC sequences to use for the other reference signal. Here, these two ranges are not consecutive. Then, when there are a plurality of (two) ZC sequences to use for reference signals in each transmission bandwidth (i.e. in each number of RBs), one ZC sequence is selected from each range.

Although cases have been explained with the above embodiments where sequence indexes of the start positions of ZC sequences used for reference signals are determined by giving an offset the sequence indexes, according to the present invention, sequence indexes at the end position of ZC sequences to use for reference signals may be determined by giving an offset to the sequence index.

Further, in the above embodiments, start positions of sequence indexes for each transmission bandwidth (i.e. for each number of RBs) may be determined on a random basis.

Further, with the above embodiments, the start positions of sequence indexes may be determined such that the range of u/N of sequence indexes of ZC sequences to frequently use for reference signals in each transmission bandwidth (i.e. in each number of RBs), does not overlap with the range of u/N of ZC sequences to use for reference signals in other transmission bandwidths (i.e. other number of RBs). Frequently-used reference signals in transmission bandwidths (i.e. the number of RBs) include reference signals having a narrower transmission bandwidth. Further, frequently-used reference signals in transmission bandwidths (i.e. the number of RBs) include reference signals in transmission bandwidths (i.e. the number of RBs) in which bandwidths neighboring in RB units are not used as reference signals. Specifically, when the 11-RB transmission bandwidth neighboring the 10-RB transmission bandwidth is not used for reference signals, the 10-RB transmission bandwidth are used more often as the reference signals.

Further, in the above embodiments, as an additional condition to generate sequence groups, a ZC sequence having a greater cubic metric (CM) value may not be used as a reference signal. By this means, it is possible to reduce the tendency of using CM values between sequence groups, and the present invention provides an advantage further.

Although cases have been explained with the above embodiments where terminal 100 and base station 150 have the same table in advance, and the transmission bandwidths and the sequence groups are associated with the sequence indexes, according to the present invention, terminal 100 and base station 150 do not need to have the same table in advance, and a table may not be used as long as equivalent association is provided such that transmission bandwidths and sequence groups, and sequence indexes are associated.

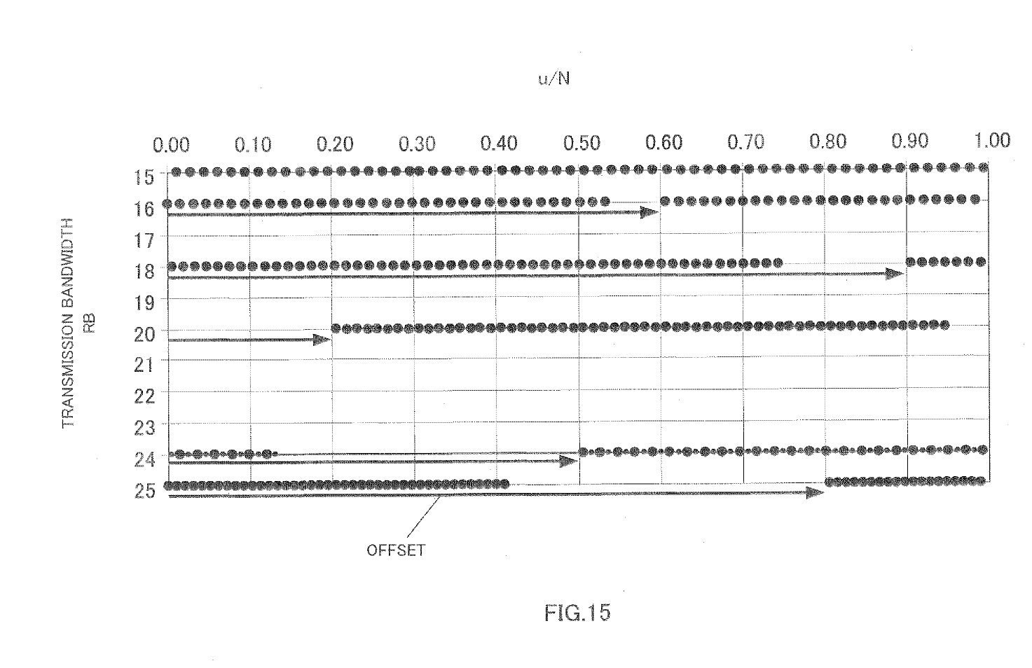

Further, although cases have been explained with the above embodiments where ZC sequences of consecutive sequence indexes are assigned as a range of ZC sequences to use for reference signals in the same transmission bandwidth (i.e. the same number of RBs), with the present invention, ZC sequences of consecutive sequence indexes may not be assigned as reference signals. For example, as a range of ZC sequences used for the same transmission bandwidth (i.e. the same number of RBs) reference signal, ZC sequences of sequence indexes having equal intervals. FIG. 15 shows the distribution of u/N when intervals of sequence indexes used for reference signals are 3 in ZC sequences of sequence lengths associated with transmission bandwidths of 15 RBs to 25 RBs. For example, in the 16-RB transmission bandwidth (sequence length N−191), if the offset is 115, the ZC sequences to use for reference signals have sequence index u=116 (=1+115), 119 (=116+three intervals), 122 (=119+three intervals), . . . , 188, 1, 4, . . . , and 103. That is, the range of ZC sequences to use for reference signals is sequence index u=116 to 188 and u=1 to 103. Then, similar to the above embodiments, different offsets are given to the ranges of ZC sequences to use for reference signals in each transmission bandwidth (i.e. in each number of RBs). This enables the u/N to be dispersed further between 0 and 1 in each transmission bandwidth. Consequently, it is possible to reduce inter-sequence interference between ZC sequences of varying sequence lengths as in the present invention.

Further, although cases have been explained with the above embodiments as an example where the terminals transmits data and reference signals to the base station, it is equally possible to apply cases where the base station performs transmission for terminals.

Although cases have been explained with the above embodiments where a ZC sequence is used as a channel estimation reference signal, with the present invention, a ZC sequence may be used as a DM-RS (Demodulation RS), which is a demodulation reference signal for a PUSCH (Physical Uplink Shared Channel), a DM-RS, which is a demodulation reference signal for a PUCCH (Physical Uplink Control Channel), and a sounding RS for received quality measurement. Further, a reference signal may be replaced with a pilot signal.

Further, the method of processing in base station 100 is not limited to the above and may be any method as long as a desired wave and interference waves can be separate. For example, cyclic-shifted ZC sequences instead of ZC sequences generated in ZC sequence generation section 166 may be outputted to division section 160. Specifically, division section 160 divides signals received as input from demapping section 159 by cyclic-shifted ZC sequences (the same sequences as the cyclic-shifted ZC sequences transmitted in the transmission side), and outputs the division results (correlation values) to IFFT section 161. Then, by masking the signals received as input from IFFT section 161, masking processing section 162 extracts the correlation value in the period where the correlation value of the desired cyclic shift sequence is present, and outputs the extracted correlation value to DFT section 163. Here, masking processing section 162 does not need to take into account of the amount of cyclic shift upon extracting the period where the correlation value of the desired cyclic shift sequence is present. These processing make it possible to separate a desired wave and interference waves from a received wave.

Although cases have been explained with the above embodiments as an example of a ZC sequence having an odd-numbered sequence length, the present invention may be applicable to a ZC sequence having an even-numbered sequence length. Further, the present invention may be applicable to a GCL (Generalized Chirp Like) sequence including a ZC sequence. Now, a GCL sequence will be represented using equations. A GCL sequence of sequence length N is represented by equation 5 where N is an odd number, and represented by equation 6 where N is an even number.

$$\begin{matrix}( Equation 5 ) & \\ {c}_{r , m} ( k ) = exp \{ \frac{- j2π r}{N} ( \frac{k ( k + 1 )}{2} + q k ) \} {b}_{i} ( k mod m ) & [ 5 ] \\ ( Equation 6 ) & \\ {c}_{r , m} ( k ) = exp \{ \frac{- j2π r}{N} ( \frac{{k}^{2}}{2} + q k ) \} {b}_{i} ( k mod m ) & [ 6 ]\end{matrix}$$

Here, k=0, 1, . . . and N−1, “N” and “r” are coprime, and r is an integer smaller than N. Also, “p” represents an arbitrary integer (generally p=0). Also, bᵢ (k mod m) is an arbitrary complex number and i=0, 1, . . . and m−1. When cross-correlation between GCL sequences is minimized, an arbitrary complex number of amplitude 1 is used for bᵢ (k mod m). In this way, the GCL sequences represented by equations 5 and 6 are found by multiplying bᵢ (k mod m) by ZC sequences represented by equations 1 and 2.

Further, the present invention may be applicable to binary sequences and other CAZAC sequences where a cyclic shift sequence or ZCZ sequence is used for a coding sequence.

Furthermore, a modified ZC sequence obtained by puncturing, performing cyclic extension or performing truncation on a ZC sequence may be applied.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-337241, filed on Dec. 27, 2007, including the specification, drawings and abstract, is incorporated herein by reference in its entirety.

### INDUSTRIAL APPLICABILITY

The present invention is applicable to, for example, mobile communication systems.

1. A sequence index setting method that uses, as reference signals, Zadoff-Chu sequences having sequence lengths according to reference signal transmission bandwidths, the method comprising: determining start positions of different sequence indexes at the Zadoff-Chu sequences having different sequence lengths.

2. The sequence index setting method according to claim 1, wherein the start positions are determined by giving different offsets sequence indexes of the Zadoff-chu sequences having the different sequence lengths.

3. The sequence index setting method according to claim 1, wherein the start positions are determined such that one or more ranges of Zadoff-Chu sequences to use for the reference signals in transmission bandwidths of 4 resource blocks or more are included in a range before and after 1/2 N (=1/62) of each u/N (u(sequence index)=1, 2, . . . and 30 and N (sequence length)=31) of a 3-resource block reference transmission bandwidth.

4. The sequence index setting method according to claim 1, wherein, between neighboring transmission bandwidths, the start position in one transmission bandwidth is determined to be a sequence index having a value near u/N (u: sequence index and N: sequence length) of a tail Zadoff-Chu sequence in the other transmission bandwidth.

5. The sequence index setting method according to claim 3, wherein, the start position is determined to be a sequence index that is greater than the u/N (u: sequence index and N: sequence length) and that is a closest value to the u/N.

6. The sequence index setting method according to claim 1, wherein, the start position is one of sequence indexes of a plurality of Zadoff-Chu sequences located at heads of a plurality of ranges obtained by dividing ZC sequences of each sequence length.

7. The sequence index setting method according to claim 1, wherein the start position is one of offset candidates, the offset candidates being a plurality of sequence indexes associated with equally-divided u/N (u: sequence index and N: sequence length) obtained by equally dividing u/N values of the Zadoff-Chu sequences.

8. A radio communication terminal apparatus comprising:
a determination section that determines a sequence index of a Zadoff-Chu sequence based on association between reference signal transmission bandwidths and sequence indexes of Zadoff-chu sequences; and
a generation section that generates the Zadoff-Chu sequence based on the determined sequence index,
wherein start positions of different sequence indexes are determined at Zadoff-Chu sequences of varying sequence lengths.

9. A radio communication base station apparatus comprising:
a determination section that determines a sequence index of a Zadoff-Chu sequence based on association between reference signal transmission bandwidths and sequence indexes of Zadoff-chu sequences; and
a generation section that generates the Zadoff-Chu sequence based on the determined sequence index,
wherein start positions of different sequence indexes are determined at Zadoff-Chu sequences of varying sequence lengths.
